(19) United States
(12) Patent Application Publication
(10) Pub. No.: US 2006/0054056 A1
(43) Pub. Date: Mar. 16, 2006

(54) Process for producing manufactured concrete products with reduced efflorescence

(75) Inventor: Axel E. Jungk, Malnz (DE)

Correspondence Address: MCANDREWS HELD & MALLOY, LTD, 500 WEST MADISON STREET, SUITE 3400, CHICAGO, IL, 60661, US

(73) Assignee: Rockwood Pigments NA, Inc.

(21) Appl. No.: 11/135,907

(22) Filed: May 24, 2005

Related U.S. Application Data
(60) Provisional application No. 60/609,499, filed on Sep. 13, 2004.
(60) Provisional application No. 60/622,281, filed on Oct. 26, 2004.

(51) Int. Cl. C09K 3/00; C04B 14/00

(52) U.S. Cl. 106/38; 106/401

(57) ABSTRACT

A process to manufacture concrete products with reduced or no efflorescence by using one or more chemicals that can act as water absorbents, which can be absorbents, super absorbents, or thickeners, either alone or in combination with other common concrete additives. A liquid color preparation and a granular color preparation with integrated water absorbents are also disclosed.

### RELATED APPLICATIONS

The present application claims priority from the provisional application U.S. Ser. No. 60/609,499 filed on Sep. 13, 2004, and the provisional application U.S. Ser. No. 60/622,281 filed on Oct. 26, 2004. Both provisional applications are explicitly incorporated herein by reference in their entirety.

### BACKGROUND OF THE INVENTION

The present invention relates to a method to reduce efflorescence in manufactured concrete products with one or more chemicals that can act as water absorbents, super absorbents, or thickeners, either alone or in combination with other common concrete additives.

Concrete is a well-proven and widely used material in construction, which in its form of decorative concrete also satisfies aesthetic requirements. The pigmenting of concrete provides decorative concrete with a long-lasting tint, requiring nearly no maintenance for years.

Colored concrete is used, for example, for facades, plates, cobblestones, tiles, anti-noise embankments, retaining walls, dikes, bridges and similar constructions, and in the form of colored mortar and of roughcast, also for decorating facades.

Concrete is usually colored by inorganic pigments, mainly in their modern form of granules, and more recently by organic pigments.

When concrete is manufactured, stored, or exposed to weather, salts and water soluble minerals in the concrete often form whitish salt coatings on the concrete's surface. These salts and minerals are inherently present in concrete, mainly contributed by the Portland cement. They are mainly calcium oxide and hydroxide, sodium sulfate, potassium sulfate, magnesium salts and other minerals in Portland cement. These water-soluble concrete components can migrate via water through the concrete capillaries and pores by diffusion processes to the concrete surface. Once a salt solution is dried by wind and weather on the concrete surface, salts precipitate and form the whitish, sometimes yellowish and even brownish coating (especially when iron ions are present). When the concrete is wetted again by condensing water, dew, fog, rain, snow or ice, the moisture, now from an outside source, can re-penetrate into the concrete pores and capillaries. The moisture can dissolve more soluble salts and minerals, transport them via a diffusion process onto the concrete surface again and, upon drying, deposit another layer of salts and hydroxides on the concrete surface. Without being bound by any theory, this explains why these salt deposits, which are called “efflorescence,” may reach several millimeters (mm) and even centimeters (cm) in thickness. Due to its very nature, hydrated cement is an inexhaustible source for such efflorescence.

Especially, calcium and magnesia hydroxides in the concrete, when they are still moist, can absorb carbon dioxide and sulfur dioxide from the environment, and then turn into nearly insoluble carbonates or, by oxidation, into nearly insoluble sulfates. These contaminants are only removable from the concrete surface by costly chemical (e.g., using acid) and/or mechanical (e.g., by brushing) treatments.

Although these efflorescence deposits have no known negative impact upon the desired mechanical properties of concrete, they do cover the concrete surface and hide the wanted structures and colors of the concrete product. They often convey to concrete an unwanted gray and pale look that is responsible for the concrete's bad visual reputation. For aesthetic reasons, efflorescence is usually unwanted, as it can diminish the commercial value of exposed concrete products significantly.

Guided by the above-described mechanism of efflorescence, a number of ways have been tried in the prior art to avoid or diminish efflorescence.

One of the ways is to block the pores and capillaries present in concrete or to reduce the number or diameters of them, to diminish and even avoid the diffusion processes discussed above. These pores and capillaries are present because concrete is made from a mechanical mixture of materials with diameters (1) of several centimeters to millimeters (e.g., the aggregates, sand), (2) in the range of from 20 to 30 microns (e.g., cement), and (3) of several nanometers (e.g., pigments and silica fume). These materials can form a very dense mass. But the densification process can be slowed down or even made impossible by the friction of the various particles against one another. Therefore, even after a sound compaction of the concrete, there remain numerous pores and capillaries. Moreover, because concrete comprises both natural materials (e.g., sand aggregates) and Portland cement, it cannot form a perfect sieve line that can theoretically yield a pore and capillary free 100% solid concrete.

To increase concrete densification and at the same time decrease the number and diameters of pores, it is common to add plasticizers and/or super-plasticizers to the concrete mixture. These chemical additives interact mainly with ions and electrically charged particles in the concrete mix. They replace water that was linked via hydrogen bonds to the various ions, especially alkali and calcium ions. By doing so, the previously hydrogen-bonded and fixed water becomes mobile again, can act as a lubricant between the various solid particles of the concrete mix and thus increase the fluidity of concrete which can result in a better compaction with less pores and less efflorescence.

These chemicals and plasticisers or superplasticisers used in the prior art are mainly lignosulfonates, melamine-formaldehyde condensates, or others as described in the relevant literature, e.g., Ramachandran, V.S., Concrete Admixtures Handbook—Properties, Science, and Technology, William Andrew Publishing/Noyes (2nd Edition, 1995). Highly efficient poly acrylic-acid derivatives can also be used in high-strength self-settling concrete.

Another way to reduce the pores, and thus efflorescence, is by adding silica fume and/or fly ash into the concrete mixture. These extremely fine silicates, which have diameters in the low micron or even nanometer range are able to fill part of the voids left in the mechanical concrete mixture by the much coarser cement grains (approximately 30 micron diameter). At the same time, when properly administered and compacted, silica fume or fly ash can chemically react with cement to form calcium silica complexes, and thus efficiently reduce capillary and pore sizes. Silicates are often used together with plasticisers or superplasticisers for a better compaction, especially in high strength concrete. However, since the silicates significantly increase concrete strength due to their chemical reaction with cement, concrete producers usually reduce such concrete's cement content, and by doing so, worsen the mechanical composition of the cement mixture with respect to voids, pores and, consequently, efflorescence.

Still another way to reduce pore size is to treat concrete with carbon dioxide during the curing process. When concrete is still wet, during curing, a carbon dioxide treatment in a curing chamber causes the dissolved calcium and magnesium salts to form insoluble carbonates that precipitate in the pores, and thus block the way to water and ion transport and efficiently reduce efflorescence. However, such curing chambers are very costly and have rarely been used.

Another way to block the capillary pores has been described in European Patent No. EU 0 092 242. Here, a surface-active resin elegantly serves as a plasticiser for concrete and, upon concrete curing, turns into an insoluble polymer, narrowing and even blocking the concrete pores against the diffusion processes and thus the appearance of efflorescence.

In another way, hydrophobic agents have been added into concrete mixes. They have the function to repel any moisture from the concrete surface, so as to avoid moisture penetration into the concrete and thus avoid moisture-carried efflorescence. These hydrophobic agents or water repellants are often fatty acid derivatives, e.g., soaps, that are decomposed by the concrete alkalis into insoluble fatty acid salts, and hydroxides, silicones and silanes. Hydrophobic agents can be either added into the concrete mix or applied to the concrete surface.

Another way to reduce efflorescence is by adding alkaline carbonates such as soda, potassium carbonate, or urea, to carbonate the calcium and magnesium components of concrete into insoluble salts, and, by doing so, also seal the concrete pores.

Concrete surfaces are often sealed with polyacrylic acid derivatives to avoid moisture penetration, preserve the wet look of concrete, and stop efflorescence. Concrete itself is mixed with polymers to enhance its strength, forming polymer concrete.

U.S. Pat. No. 6,537,366, for instance, describes the use of stearates against efflorescence in combination with a particulate polymer to enhance concrete strength and internally seal it. The particulate polymer is selected from the group consisting of styrene-based polymers and copolymers, acrylic-based polymers and copolymers, polyvinyl acetates, polyepoxides, polyurethanes, butadiene rubbers, and a mixture thereof. The concrete composition of this patent further uses a colorant. This composition improves the durability of the concrete color because the hydrophobic stearates help to reduce efflorescence.

The use of water absorbents such as organic thickeners, absorbents or super absorbents together with hydraulic binders is known in the art. Examples of water absorbents are cellulose and its various derivatives, such as methyl cellulose, ethyl cellulose carboxymethylcellulose, hydroxyethylcellulose, gelatinised starch, polysaccharides, polyvinyl alcohol and derivatives, polyacrylamides, plant gums, polyethylene oxides, guar gum, gum tracagarth, xanthan gum. These examples are described in various publications, such as CA 2295 696 A1, DE 19731698, DE 10002559, JP 11246251, KR 9200153, JP 1114774, JP11349364, JP 56114885, U.S. Pat. No. 2,427,683, U.S. Pat. No. 2,629,667, U.S. Pat. No. 2,934,932, U.S. Pat. No. 3,215,549, U.S. Pat. No. 3,243,307, U.S. Pat. No. 3,762,937, U.S. Pat. No. 3,824,107, U.S. Pat. No. 3,847,630, U.S. Pat. No. 4,011,094, U.S. Pat. No. 4,065,319, U.S. Pat. No. 4,082,563, U.S. Pat. No. 4,188,231, U.S. Pat. No. 4,501,617, U.S. Pat. No. 4,573,534, U.S. Pat. No. 5,674,929, U.S. Pat. No. 5,746,822, U.S. Pat. No. 6,635,107.

Other examples pertain to superabsorbing polyacrylates and starch modified superabsorbing acrylates, insoluble, non flocculating water swellable cross linked cellulose ethers, cross linked sulfonated monovinylidene polymers, reactive water soluble cellulose derivates together with a cross linking agent, specifically produced water absorbent polymers, and Mannich acrylamide polymers with dimethyldiallylammonium halides, such as those described in DE 19539250, U.S. Pat. No. 4,487,864, U.S. Pat. No. 4,778,529, U.S. Pat. No. 5,164,428, U.S. Pat. No. 5,391,597.

Still other proposed absorbents are fully or partially hydrolyzed polyvinyl alcohol such as those described in U.S. Pub. Pat. App. No. 2002/0042459.

However, these thickeners or absorbers are mainly utilized to retain water in mortars, hydraulic adhesives, or sprayed concrete, to improve the rheological properties of sprayed concrete or mortar, to increase the sag resistance of adhesives, to improve their adhesion to substrates, especially to water absorbing substrates, to improve shrinkage, and to prevent bleed-out in cement and concrete slurries.

These thickeners or absorbents are also used as disintegrators (explosives) in compacted pigment granules for use in concrete and also to retard the hydration of a cement slurry in oil wells, to improve workability, plasticity and pumping properties for mortar and concrete as a substitute for the asbestos fibres in sag resistant dry set mortar, to improve waste compositions together with a hydraulic binder.

KR 9288153 teaches specially casted cement-containing products that comprise cellulosic additives and/or polyvinyl alcohol and silicate foam. These products show decreased or no efflorescence.

DE 10002559 discloses a composition that uses the materials of DE 19731698 (cellusosic water absorbents) as a disintegrating agent in a process to color concrete. However, this patent uses chemical compounds that form insoluble salts with the earth-alkali ions of the cement to reduce or prevent efflorescence.

JP 11246251 describes the production of molded concrete. In a process of that reference, a mixture of hydraulic binders, a polymer (from the group of cellulose compounds, polyvinyl alcohol and polyacrylamide), silicate sand, dye, fibres, alkali carbonates and water, is hardened in a CO₂ atmosphere to produce molded concrete products with reduced efflorescence. However, it is known in the art, that the hardening of concrete in a CO₂ atmosphere and the use of alkali carbonates, reduce and even block the formation of efflorescence by sealing the surface of the concrete product by formation of insoluble calcium carbonates.

WO 02/28796 describes a construction material made from cellulose fibre cement. However, in order to reduce efflorescence, some of the cellulose fibres are loaded with insoluble substances.

JP 56149361 describes a construction material made from polymer concrete containing fibres with reduced efflorescence.

JP 1114774 describes concrete compositions comprising water-absorbing substances, wherein efflorescence is reduced via the use of alkali carbonates.

DD 265615 describes a mixture to reduce sulphate based efflorescence in gypsum. The mixture comprises a hydraulic binder, quartz sand, a water-soluble barium compound, a plasticizer and stabilizing additives such as cellulose derivatives.

U.S. Pat. No. 5,164,428 provides a process to manufacture a special, not commercially available water absorbing polymer under complex and well defined conditions. The polymer is stated to be suitable to hold frozen water in the form of fine grain ice. It also provides a process to produce fine grain ice, and then use the fine grain ice, which is contained in the special polymer, to manufacture a concrete/mortar with a low water content. The patent indicates that the use of this special polymer may remarkably reduce efflorescence and surface dew. However, the technology disclosed in this patent uses a non-commercially available polymer and is limited to concrete or mortar.

Another related reference is U.S. Pat. No. 4,946,505 which describes certain pigment granules well suited for pigmenting concrete. See also U.S. patent application Ser. No. 10/836,288, filed Apr. 30, 2004, now pending.

All these known techniques have not yet yielded a satisfactory result with respect to the reduction of efflorescence in an economical way. Furthermore, it is believed that the use of water absorbents, especially when activated in situ by an alkaline environment during the production of manufactured concrete articles, has hitherto not been described in the prior art and is unknown.

### BRIEF SUMMARY OF THE INVENTION

In one aspect, the presently described technology includes a process for producing manufactured concrete articles that show reduced efflorescence or no efflorescence.

In this aspect, water absorbents are mixed with cement, sand, aggregates and/or fibers, and water, and eventually with other admixtures such as pigments or additives, at conditions to produce a generally homogeneous dispersal of the absorbents, super absorbents and/or thickeners in concrete. The concrete is then formed and potentially densified. Optionally, forming and densifying of the concrete may occur in a single step. The concrete can then be cured.

In another aspect, the presently described technology provides a liquid pigment composition containing water absorbents for coloring concrete. Such liquid pigment compositions contain: at least one pigment; at least one water absorbent present in an amount effective to reduce efflorescence in concrete pigmented with the liquid pigment composition; from about 20% to about 70% water; and, optionally, at least one dispersant, other than the water absorbent, for promoting the dispersal of the pigment in the concrete. In a preferred embodiment, the nature and pH of the liquid pigment composition is such that the water absorbent present is inactive until the pH is raised, activating the water absorbent, by mixing the pigment composition with Portland cement or other additives. Liquid pigment compositions of the presently described technology when used to dye manufactured concrete articles can reduce efflorescence significantly.

In another aspect, the presently described technology provides a granular pigment composition containing: at least one pigment; at least one water absorbent that will also function as a binder, present in an amount effective to reduce efflorescence in concrete pigmented with the granular pigment composition and, optionally, at least one binder other than the at least one water absorbent. Optionally, the granular pigment composition can contain from about 0% to about 4.2% water.

Pigment granules of the presently described technology when used to dye manufactured concrete articles can reduce efflorescence significantly.

### BRIEF DESCRIPTION OF SEVERAL VIEWS OF THE DRAWINGS

[Not Applicable]

### DETAILED DESCRIPTION OF THE INVENTION

In the presently described technology, the term “manufactured concrete products” relates to uniform concrete articles made from a composition that contains, among other things and before any chemical reaction, one or more hydraulic binders (e.g., cement), and/or fly ash, silicates, fumed silica, and sand, aggregates and/or fibers, and potentially other additives such as air entraining agents, plasticisers, hydrophobic agents and others. Such manufactured products are provided in the form of slabs, plates, tiles, roofing tiles, paving stones, interlocking paving stones, retaining walls, architectural blocks or other products.

In this specification, the term “water absorbent” refers to an absorbent, super absorbent or thickener that, whether natural or synthetic, upon contact with water, optionally activated by contact with alkaline water, will immobilize and absorb many times its own weight of water and keep the water physically and physico-chemically bound.

Bound water in a concrete mix will not migrate and transport salts to generate efflorescence before or after it becomes concrete, but remains available for the relevant chemical reactions in the concrete mix to make it change to concrete.

Absorbents, super-absorbents or thickeners of the presently described technology will also immobilize water absorbed from the environment of the concrete in the frame of their molecules and molecular networks to reduce or even inhibit diffusion of calcium and other ions present in the alkaline concrete water to the concrete surface, and by doing so, reduce and even prevent efflorescence.

In a preferred embodiment of the presently described technology, these chemicals can at the same time render the concrete mix thixotropic, which means to give the concrete mix a high mechanical stability when at rest, but to let it liquefy and become fluid upon impact of shear through, for instance, the concrete mixing process, or during the densification of concrete in a mold for pavers, retaining walls, slabs or blocks through inducement of vibrations. This thixotropic property of concrete is also advantageous in manufacturing slabs or other manufactured concrete products, for which the mechanical stability of a demoulded concrete article is important.

Preferably, the water absorbents according to the presently described technology are chemicals that can bind physically up to more than 1000 times their own weight in aqueous liquid, and thus immobilize that liquid. These water absorbents are, for instance, widely used in the food industry to prevent settling of suspensions like ketchup, to stabilize jellies, cremes and other products such as xantham gum, guar, carrageen, pectins and their equivalents.

Other chemicals that can be used in the presently described technology as water absorbents are starches, cellulose, caboxymethyl cellulose, hydroxyethyl cellulose, and similar cellulose derivatives with a low or no water (especially alkali water) solubility. These chemicals can be, for example:
Lysorb™ series by Lysac Technologies Inc. (Quebec, Canada) which are starch derivatives with an approximately 20-fold water absorption capacity;
the Optixan™ and Novaxan™ products and equivalents by Archer Daniels Midland Company (ADM) (Decatur, Ill.);
Cellosize™ line of hydroxyethyl cellulose polymers from Dow Chemicals Co. (Midland, Mich.);
Natrosol™ hydroxyethyl cellulose ether polymers from Hercules Inc. (Wilmington, Del.);
the Aquaflow™ series of rheology modifiers from Hercules Inc. (Wilmington, Del.);
the Admiral™ series of fluidized cellulose based polymer suspensions from Aqualon Co. (Wilmington, Del.);
the Aqualon™ series of carboxy methyl cellulose products offered by Aqualon Co. (Wilmington, Del.); Klucel™ hydroxypropyl cellulose from Hercules Inc. (Wilmington, Del.);
cross-linked polyacrylate polymers of the Carbopol™ series from Noveon, Inc. (Cleveland, Ohio), or the cross-linked polyacrylate polymers like Pemulen™ from Noveon, Inc. (Cleveland, Ohio);
alkali swellable emulsions (ASE) from Rohm & Haas Co. (Philadelphia, Pa.), e.g., the Acrysol™ ASE series;
synthetic hydrophobically modified acrylate polymers, e.g., the ACUSOL™ S series from Rohm & Haas Co. (Philadelphia, Pa.);
cross-linked polyacrylates, sold for example as Liqui Block™ products by Emerging Technologies Inc. (Greensborough, N.C.);
hydrophobically modified ethylene oxide urethane block copolymers, some of which are sold under the Acrysol™ tradename by Rohm & Haas Co. (Philadelphia, Pa.); or
alkali swellable urethane modified rheology control products, for instance the UCAR Polyphobe™ series from Dow Chemical Co. (Midland, Mich.).

Water absorbents suitable for use in the presently described technology can also be found in the personal hygiene markets in diapers and similar products, for instance, the Aquakeep™ and Norsocryl™ series from Atofma Co. (Puteaux, France), and the super absorbents series of products from BASF Corp. (Florham Park, N.J.).

Other water absorbents suitable for use in the presently described technology are those used in the paint industry, especially those for stabilizing aqueous paints (dispersion paints) and conveying a certain thixotropy to the paints, and in the paper coatings application. Examples of such water absorbents are high molecular weight polyacrylic acid resins that are crosslinked with polyalkenyl polyether, e.g., the Carbopol™ series of resins from Noveon, Inc. (Cleveland, Ohio). Other examples are the ACRYSOL™ series of alkali swellable anionic thickeners/water absorbents available from Rohm & Haas Co. (Philadelphia, Pa.). Further examples are cellulose and its derivatives that are used in dispersion paints, or those used as glues and admixtures in mortar. Even though it is not completely clear about how these absorbents function to reduce efflorescence, without limiting the presently described technology to any specific explanation, it is believed that they work as follows.

Upon dispersing, the absorbents, super absorbents or thickeners of the presently described technology in the concrete mix will slowly start to absorb and then physically bind water. Once the concrete mass has been formed and is curing, the absorbents, super absorbents or thickeners will develop their full efficiency and physically absorb any liquid water. They are believed (without limiting the invention to this theory of how they work) to fill the voids and capillary pores of the concrete and, by absorbing the water, they prevent the salts from migrating from the inner parts of the concrete to the surface. The water and ions are believed to remain immobilized by the absorbents inside the concrete. At the same time, the absorbents can also provide water that is needed for the chemical reactions with the hydraulic material. Therefore, concrete can form and cure as usual, but with significantly reduced efflorescence or no efflorescence at all.

Upon being wetted by condensation, rain, fog or snow, the absorbents, super absorbents or thickeners of the presently described technology are believed to again physically bind and immobilize moisture absorbed into the concrete, not allowing the ions to be diffused to the concrete surface.

Depending upon its reaction velocity, an absorbent, super absorbent or thickener may increase the viscosity of the concrete mix and intensify shear in the mix for a faster and better dispersion of its components and make it thixotropic. If this higher viscosity impacts upon concrete compaction during the manufacturing process of various concrete products, the viscosity of the mix may be lowered to its desired level by the use of a small amount of additional water and/or a small amount of plasticiser or superplasticiser. The absorbents, super absorbents or thickeners of the presently described technology may also render the concrete mix thixotropic, which conveys to a fresh concrete a higher mechanical strength when at rest, but lets it become fluid again and enhances its compaction when the fresh concrete is poured into its form, for instance a paver mold, or when it is subject to vibration to compact it in the mold.

Preferably, in the presently described technology, one may choose a water absorbent that is activated by the alkaline pH environment present in concrete during the mixing process. Examples of absorbents particularly suitable for use in concrete are those absorbents that increase their efficiency or even only display their significant water absorbing activity in an alkaline pH environment, for example, the Acrysol™ and Carbopol™ alkali swellable cross-linked polyacrylates mentioned above. Some commercial products such as the Acrysol™ compounds having a pH value of lower than 7 and Carbopol™ compounds, especially the Aqua 30 series, come in an acidic form and will display their moisture absorbing properties mainly after being neutralized when they are used in concrete, due to the presence of calcium ions from the calcium hydroxide dissolved by water from cement. These absorbents become effective during the production of the concrete, and therefore are favored. These are especially suitable for use in liquid pigment compositions with low pH values.

These kinds of chemicals are also suitable for being incorporated into pigment granules by aqueous granule production methods, since they do not absorb significant amounts of water in a non-alkaline pH environment.

Another favored absorbent is cellulose, especially water insoluble cellulose with small fibers, with a length between 20-500 microns (preferably between 20 microns to 200 microns) and a crystallinity of 50% or less.

The necessary amount of water absorbent to be added to the concrete mix depends on its efficiency, i.e. how much water it can physically bind in an alkaline concrete environment.

The common proportions of the water absorbent lie between 0.05% to 5% by weight based on the weight of cement and/or other hydraulic binders. A preferred dosage rate lies between 0.1 to 2.0% or more preferably between 0.1 to 0.9% by weight based on the weight of cement and/or other hydraulic binders.

The water absorbent may be added any time during the cement mixing cycle, so long as the absorbent, super absorbent or thickener and other components of the concrete mix can be homogeneously dispersed. If the absorbent, super absorbent or thickener is an aqueous emulsion or suspension, it is recommended to meter it together with the sand and aggregates for better dispersion in the concrete mixer. It also may be added after the concrete mix has been thoroughly mixed together with water. Adding the aqueous suspension into the cement directly might lead to lumping of the absorbent, super absorbent or thickener and may require more intense mixing of the concrete mix for a complete homogeneous dispersion.

The water absorbent may also be an integral part of the pigment preparation added to the concrete. If aqueous liquid color systems are used, it is advantageous for reasons of the flowability and pigment load of the liquid pigment preparation that the pH of that color preparation is chosen to keep the water absorbent inactive. For instance, when using alkali swellable absorbents or thickeners, the pH value of the color preparation should be from acidic to neutral.

When the water absorbent is integrated as part of the pigment preparation, the pigment preparation should contain a sufficient amount by weight of the water absorbent based on the dry weight of the pigment preparation. The sufficient amount of water is easily calculated when considering the amount of pigment preparation to be used in the process and the desired load of water absorbent in a range as indicated above, i.e. between 0.05 and 5 wt. % of absorbent per weight of Portland cement. For instance, at a 3 wt. % pigment loading (also per weight of Portland cement), the loading of water absorbent per weight of pigment will be between 1.67% weight of pigment for a 0.05% load (i.e. 0.05/3) of the water absorbent up to 167% (i.e. 5/3). For a preferred water absorbent load of between 0.1 to 2% per weight cement at a 3% per weight cement of pigment load cement, the loading of water absorbent per weight of pigment will be between 3.34% weight of pigment for a 0.1% load (i.e. 0.1/3) of water absorbent up to 67% (i.e. 2/3) For a preferred water absorbent load of between 0.1 to 0.9% per weight cement at a 3% per weight cement of pigment load cement the loading of water absorbent per weight of pigment will be between 3.34% weight of pigment for a 0.1% load (i.e. 0.1/3) of respective water absorbent up to 30% (i.e. 0.9/3)

Any methods that are now known or will be known in the art to produce pigment granules can be used to make pigment granules incorporating water absorbents. For example, U.S. Pat. No. 4,946,505 teaches a process to produce pigment granules other than compacted or briquetted granules, and a process to use the pigment granules to dye concrete. U.S. Pat. No. 4,946,505 is hereby incorporated by reference in its entirety to provide ingredients and an exemplary method to make and use pigment granules for dying concrete. Other information about granulating equipment and methods can be found in U.S. Pat. Nos. 4,946,505, 6,695,990 and 6,132,505, which are all incorporated herein by reference in their entirety.

If the water absorbent is integrated as part of sprayed pigment granules, upon production of the granules, which can be done, for instance, via a spray granulation process, the water absorbing properties should not develop in the pigment slurry to negatively impact upon the atomization of the pigment slurry during the spray granulation process. This can be done, for instance, by a last minute addition of the water absorbent to the sprayed pigment slurry or again by controlling the appropriate pH environment in the aqueous system to be spray granulated.

These and other granular pigment compositions of the presently described technology may comprise one or more pigments, one or more water absorbents, potentially one or more binders for promoting the dispersing of the pigments in the concrete (in certain embodiments the water absorbents may perform the function of the binders or vice versa, in whole or in part), and other optional additives. The pigment granules of the presently described technology can be made, for example, by spray-drying the pigment, binder and water absorbent; by compacting the pigment, binder, and water absorbent; by briquetting the pigment, binder, and water absorbent; by pin-milling the pigment, binder, and water absorbent; by drum drying the pigment, binder, and water absorbent; by belt drying the pigment, binder, and water absorbent; or by agglomerating the pigment, binder, and water absorbent. In one embodiment, granular pigment compositions of the presently described technology are made by: (a) forming the ingredients of the composition into at least two types of granules having different compositions; and (b) blending the types of granules having different compositions.

Such pigment granules, particularly bead granules, can easily dissolve in the concrete mixer and can be homogeneously dispersed in the concrete. The pigment concrete mix can then be used to produce manufactured concrete products with reduced or no efflorescence. The presently described technology naturally may be used in the manufacture of other granules, compacted granules, agglomerated granules and so forth.

The presently described technology and its advantages will be better understood by reference to the following examples. These examples are provided to describe specific embodiments of the present technology. By providing these specific examples, the inventor does not limit the scope and spirit of the presently described technology. It will be understood by those skilled in the art that the full scope of the presently described technology encompasses the subject matter defined by the claims appending this specification, and any equivalents of the claims. In the subsequent examples black concrete was used to more easily identify the whitish efflorescence.

Example 1 and Control Example 1 show the anti-efflorescence additive functioning in the field.

### EXAMPLE 1

A 2 m³ turbo concrete mixer was operated for 20 seconds to mix 1850 kg sand, 1100 kg of gravel, 21.2 kg iron oxide black granules (AXEL SMARTLiNS™, supplied by AXEL J, LP, Bromont, Canada) and in accordance with the invention 0.6% by weight (3.2 kg) of a water absorbent—Acrysol™ TT 935, an alkali swellable cross-linked polyacrylate (available from Rohm and Haas Co., Philadelphia, Pa.—based on the weight of cementlhydraulic binder (i.e., Portland cement in this example). Thereafter 530 kg Portland cement was added together with 90 kg of water to ensure the required concrete consistency. The mix was homogenized for 90 seconds to yield a homogeneous dispersal of the components in concrete. Thereafter, the concrete was used to produce interlocking paving stones.

The paving stones were black upon production and did not show any efflorescence 28 days after curing.

### CONTROL EXAMPLE 1

The same procedure was followed as in Example 1, but without adding the water absorbent. The desired concrete consistency required the use of 64 kg of water.

The paving stones of Control Example 1 were grayish upon production and showed significant whitish efflorescence 28 days after curing when they were stored side by side with the pavers from Example 1.

Example 1 together with Control Example 1 demonstrates the efficiency of the use of a water absorbent according to this invention as an anti-effloresecent agent.

The following examples compare results of some state-of-the-art anti-efflorescence systems, the efflorescence inhibitors according to the presently described technology and their functioning either alone or together with concrete plasticizers.

### EXAMPLE 2

In the laboratory, small pavers with the dimensions of 1.9 cm thick, 7.5 cm×5.5 cm bottom, 6.5 cm×4.5 cm top, were prepared by using the following materials:
200 grams sand;
70 grams grey cement;
3.5 grams of Chinese black iron oxide pigment, type K-780;
0.5 grams of Polystar™ (Test #1), a commercially available efflorescence inhibitor from Interstar Co., Sherbrooke, Qc, Canada; or Acrysol™ TT935 (Test #2); or nothing (control experiment, Test #3);
23 grams water
   These materials were mixed in a kitchen mixer for 4 minutes, until homogeneous.

The mortar mixes were placed into molds. They were lightly tapped 20 times to allow the concrete to settle properly, and then 10 times to compact it to form a small paver.

These pavers were dried for 3 hours at 75° C. Their appearance thereafter was as follows:

Results:

Test # 1 with Polystar™: the paver looks uniformly grey and shows significant, heavy efflorescence.
Test # 2 with Acrysol™ TT935: The paver has uniformly black colored and shows no significant efflorescence.
Test # 3 control with no additive: The paver has a medium colored surface contaminated by efflorescence and shows pics.

The tests were repeated three times, showing each time essentially the same results.

These test results show, now in the laboratory setting, the superior functioning of the anti-efflorescence system according to the presently described technology.

### EXAMPLE 3

In the series of tests in this example, the concrete mix design was changed so that the applied sand was free of fine particles smaller than 355μ to artificially enhance the porosity of the concrete and therefore its tendency to effloresce.

In this series of tests, pavers were made from the following materials:
200 grams sieved sand limited to aggregates greater than 355 microns for higher porosity;
70 grams grey cement;
0.7 grams of Carbopol™ Aqua 30, a polyacrylic acid thickener by Noveon, Inc. (Cleveland, Ohio) (Test # 4) or nothing (Control Test # 4); and
23 grams water.
   These materials were mixed in a kitchen mixer for 5 minutes until homogeneous.

The concrete mixes were placed into molds; they were tapped lightly 20 times to allow the mortar to settle properly, and then 10 times to compact the mixes to form small pavers.

The pavers were cured in the laboratory at room temperature over a period of 24 hours and then placed into a lab oven at 100° C. for 60 minutes to completely dry the pavers.

The pavers were compared for initial efflorescence: Test #4 with the Carbopol™ Aqua 30 thickener showed significantly less efflorescence than the control sample of Control Test #4.

Efflorescence of the pavers after water treatment was also tested. These tests were designed to simulate the impact of efflorescence-generating moisture that contacts concrete surfaces exposed to weather. Three grams of water were placed onto the surface of each paver of Test #4 and Control Test #4. The pavers of both Test #4 and Control Test #4 absorbed the water within 5 seconds. These pavers were then dried in an oven at 100° C. for 25 minutes. The paver of Test #4 showed minimal efflorescence. The paver of Control Test #4 showed significant efflorescence.

### EXAMPLE 4

Another series of tests in the laboratory were performed in black concrete to see the influence of dispersants with the absorbents. In these tests, 200 grams of sand sieved to remove undersize particles using a 355-micron sieve, 70 grams grey cement, 3 grams black iron oxide, 23 grams of water, and the ingredients described below were mixed in a KitchenAid™ mixer for two minutes while tapping the side to avoid any build up of concrete. This technique allows for adequate development of color.

Acrysol™ TT935 and Carbopol™ (“Carbo.”) Aqua 30 were used as absorbents. Dispersants, such as Disal™ (a naphthalene sulfonate, available from Handy Chemicals Ltd. Corp., Quebec, Canada) and Wanin™ (a lignosulphonate from SKB Co in Stockholm, Sweden) were used in combination with these absorbents in some tests. These chemicals were added to water before being added to the mix of sand, cement, and pigment.

The sample numbers and recipe for absorbents and/or dispersants follow:

| 1. Control: concrete recipe without other chemicals. | | | |
|---|---|---|---|
| 2. | Acrysol TT935 | 0.35 grams. | = 0.5% to cement |
| 3. | Acrysol TT935 | 0.70 grams | = 1.0% to cement |
| 4. | Carbo. Aqua 30 | 0.35 grams | = 0.5% to cement |
| 5. | Carbo. Aqua 30 | 0.70 grams | = 1.0% to cement |

| | | |
|---|---|---|
| 6. | Acrysol TT935 | 0.35 grams + Disal 0.15 grams |
| 7. | Acrysol TT935 | 0.25 grams + Disal 0.25 grams |
| 8. | Acrysol TT935 | 0.35 grams + Wanin 0.15 grams |
| 9. | Carbo. Aqua 30 | 0.35 grams + Disal 0.15 grams |
| 10. | Carbo Aqua 30 | 0.25 grams + Disal 0.25 grams |
| 11. | Carbo Aqua 30 | 0.35 grams + Wanin 0.15 grams |
| 12. | Carbo Aqua 30 | 0.25 grams + Wanin 0.25 grams |

The pavers were evaluated as follows:
(1) Initial efflorescence after setting of the pavers: visual evaluation to determine if any efflorescence had developed, usually in the form of staining (ring formation at the bottom of a paver).
(2) Color reading using a standard spectrophotometer: to obtain L value [lighter (higher value)/darker (lower value)] of the top of a paver, which is an indication of more (lighter) or less (darker) efflorescence.
(3) A spectrophotometer reading to evaluate the change in efflorescence after each water contact on surface (oven-dried or air-dried is noted).
(4) The surfaces were rewet with water several times and the pavers were air-dried. Spectrophotometer readings were taken after air-drying to evaluate the change in efflorescence.
(5) Spectrophotometer measurements were also taken for comparison between the control sample and the samples produced according to the invention to evaluate differences in efflorescence.

As a quantitative measure of efflorescence, the L value, a measure of lightness/darkness, was used as an indicator of efflorescence. The higher the L value the lighter the color. The Delta L (DL) of the spectrophotometer reading is a change in lightness/darkness on the surface of the paver.

TABLE 1
Results

| | Initial Visual | L Value For | Initial DL |
|---|---|---|---|
| | Efflorescence | Top Of Paver | Compared |
| | On Bottom | Spectral | To Sample 1 |
| Sample # | of Paver | Reading (L) | (Control) |
| 1 Control Sample, No | Slight (easily | 31.25 | |
| Absorbent | visible) | | |
| 2. Acrysol TT935: 0.35 | Very slight | 27.05 | −4.2 |
| grams | | | |
| 3. Acrysol TT935: 0.70 | extremely | 27.03 | −4.2 |
| grams | slight | | |
| 4. Carbo. Aqua 30: 0.35 | Slight | 29.8 | −1.45 |
| grams | | | |
| 5 Carbo. Aqua 30: 0.70 | Very slight | 29.1 | −2.15 |
| grams | | | |
| 6. Acrysol: 0.35 grams | Very slight | 28.6 | −2.65 |
| + Disal: 0.15 grams | | | |
| 7. Acrysol: 0.25 grams | Slight | 28.2 | −3.05 |
| + Disal: 0.25 grams | | | |
| 8. Acrysol: 0.35 grams | Slight | 30.4 | −0.85 |
| + Wanin: 0.15 grams | | | |
| 9. Carbo. Aqua: 0.35 | Very Slight | 29.4 | −1.85 |
| grams + Disal: 0.15 | | | |
| grams | | | |
| 10. Carbo. Aqua: 0.25 | Slight | 27.5 | −3.75 |
| grams + Disal: 0.25 | | | |
| grams | | | |
| 11. Carbo. Aqua: 0.35 | Very slight | 28.6 | −2.65 |
| grams + Wanin: 0.15 | | | |
| grams | | | |
| 12. Carbo. Aqua: 0.25 | Very Slight | 29.5 | −1.75 |
| grams + Wanin: 0.25 | | | |
| grams | | | |

TABLE 2
Change in Efflorescence (DL) after multiple water treatments (vs. initial
color readings of same paver)

| | DL after 1^{st} | DL after 2^{nd} | DL After | DL After |
|---|---|---|---|---|
| | surface | surface | 3^{rd} | 4^{th} |
| | wetting | wetting | surface | surface |
| | (5 ml | (complete | wetting | wetting |
| | oven | saturation | (Air | (Air |
| | dried) | and dried | dried | dried |
| Sample # | 30 min.) | in oven) | surface) | surface) |
| 1 control sample, | 0.53 | 0.86 | 1.45 | 2.85 |
| no absorbent | | | | |
| 2. Acrysol TT935: | 0.8 | 1.2 | 0.65 | 0.65 |
| 0.35 grams | | | | |
| 3. Acrysol TT935: | 1.3 | 2.05 | 0.5 | 1.4 |
| 0.70 grams | | | | |
| 4. Carbo. Aqua 30: | 0.72 | 0.82 | 0.11 | −0.34 |
| 0.35 grams | | | | |
| 5. Carbo. Aqua 30: | 1.4 | 1.33 | 0.89 | −0.73 |
| 0.70 grams | | | | |
| 6. Acrysol: | 1.43 | 0.91 | 0.65 | −0.22 |
| 0.35 grams + Disal: | | | | |
| 0.15 grams | | | | |
| 7. Acrysol: 0.25 | 0.95 | 1.04 | 1.04 | 0.16 |
| grams + Disal: 0.25 | | | | |
| grams | | | | |
| 8. Acrysol: 0.35 | −0.05 | −0.8 | −1.06 | −1.8 |
| grams + Wanin: | | | | |
| 0.15 grams | | | | |
| 9. Carbo. Aqua: | −0.67 | 1.2 | 1.16 | 0.58 |
| 0.35 grams + Disal: | | | | |
| 0.15 grams | | | | |
| 10. Carbo. Aqua: | −1.3 | 0.9 | 0.34 | 0.80 |
| 0.25 grams + Disal: | | | | |
| 0.25 grams | | | | |
| 11. Carbo. Aqua: | 0.25 | 0.3 | −0.36 | −0.89 |
| 0.35 grams + | | | | |
| Wanin: 0.15 grams | | | | |
| 12. Carbo. Aqua: | −0.22 | −0.7 | −2.0 | −3.2 |
| 0.25 grams + | | | | |
| Wanin: 0.25 grams | | | | |

TABLE 3
Efflorescence change (DL) vs. control sample

| | | | DL after | | |
|---|---|---|---|---|---|
| | | DL after | 2^{nd} | DL after | DL after |
| | Initial | 1^{st} wetting | wetting | 3^{rd} wetting | 4^{th} wetting |
| Sample # | DL | (surface) | (saturated) | (surface) | (surface) |
| 1 control sample, | | | | | |
| no absorbent | | | | | |
| 2. Acrysol | −4.2 | −3.9 | −3.9 | −5.0 | −6.6 |
| TT935: | | | | | |
| 0.35 grams. | | | | | |
| 3. Acrysol | −4.2 | −3.5 | −3.1 | −4.7 | −6.3 |
| TT935: | | | | | |
| 0.70 grams | | | | | |
| 4. Carbo. Aqua | −1.45 | −1.3 | −1.5 | −3.5 | −5.4 |
| 30: 0.35 grams | | | | | |
| 5. Carbo. Aqua | −2.15 | −1.3 | −1.7 | −3.7 | −6.0 |
| 30: 0.70 grams | | | | | |
| 6.Acrysol: | −2.65 | −1.8 | −2.6 | −3.7 | −6.6 |
| 0.35 grams + | | | | | |
| Disal: 0.15 grams | | | | | |
| 7. Acrysol: 0.25 | −3.05 | −2.6 | −2.9 | −4.5 | −6.4 |
| grams + Disal: | | | | | |
| 0.25 grams | | | | | |
| 8. Acrysol: 0.35 | −0.85 | −1.4 | −2.5 | −4.7 | −6.0 |
| grams + Wanin: | | | | | |
| 0.15 grams | | | | | |
| 9. Carbo. Aqua: | −1.85 | −3.0 | −1.5 | −3.9 | −4.9 |
| 0.35 grams + | | | | | |
| disal 0.15 grams | | | | | |
| 10. Carbo. Aqua: | −3.75 | −5.5 | −3.7 | −6.8 | −6.6 |
| 0.25 grams + | | | | | |
| Disal: 0.25 grams | | | | | |
| 11. Carbo. Aqua: | −2.65 | −3.0 | −3.2 | −5.4 | −6.7 |
| 0.35 grams + | | | | | |
| Wanin: 0.15 | | | | | |
| grams | | | | | |
| 12. Carbo. Aqua: | −1.75 | −2.5 | −3.3 | −5.3 | −8.5 |
| 0.25 grams + | | | | | |
| Wanin: 0.25 | | | | | |
| grams | | | | | |

The spectrophotometer readings show the development of efflorescence in the control sample; with an increase of the L value by 2.9 Delta L units, the concrete paver has significantly lightened. At the same time, all trials comprising water absorbent according to the invention, with and without plasticizer, show a decrease in the L value and are significantly darker than the control sample. The difference with the control sample after 4 wetting cycles is between 8.5 to 4.9 Delta L units.

These results clearly show the superior performance of the water absorbent system with respect to lower efflorescence.

I claim:

1. A process for producing manufactured concrete products with reduced or no efflorescence, comprising:
(a) mixing one or more water absorbents; one or more hydraulic binders; one or more materials selected from the group consisting of aggregates, sand, fibers, pigment preparations, admixtures, or a combination thereof, and water at conditions to produce a generally homogeneous dispersal of the one or more water absorbents in concrete;
(b) forming the concrete; and
(c) curing the concrete.

2. A process according to claim 1 further comprising densifying the concrete before curing the concrete.

3. A process according to claim 1, wherein the one or more hydraulic binders comprise cement.

4. A process according to claim 1, wherein the one or more water absorbents are used in a quantity of from about 0.05% to about 5% by weight based on the weight of the one or more hydraulic binders.

5. A process according to claim 1, wherein the one or more water absorbents are used in a quantity of from about 0.1% to about 2% by weight based on the weight of the one or more hydraulic binders.

6. A process according to claim 1, wherein the one or more water absorbents are added to the concrete as part of a pigment preparation in powder form, liquid form, granular form, or a combination thereof.

7. A process according to claim 1, wherein the one or more water absorbents are activated by the alkaline environment in the concrete.

8. A process according to claim 1, wherein the one or more water absorbents are used in combination with plasticisers, superplasticisers, dispersants, admixtures, dyes, or a combination thereof.

9. A process according to claim 1, wherein the one or more water absorbents are alkali swellable.

10. A process according to claim 9, wherein the one or more water absorbents are alkali swellable cross-linked polyacrylate polymers.

11. A process according to claim 1, wherein the one or more water absorbents are activated by being incorporated into the concrete.

12. A process according to claim 1, wherein the one or more water absorbents are water insoluble cellulose or derivatives thereof.

13. A manufactured concrete product produced by the method of claim 1.

14. A liquid pigment composition comprising:
a. at least one pigment;
b. at least one water absorbent present in an amount effective to reduce efflorescence in concrete pigmented with the liquid pigment composition;
c. from about 20% to about 70% water; and,
d. optionally, at least one dispersant other than the at least one water absorbent for promoting the dispersal of the pigment in the concrete.

15. A granular pigment composition comprising:
a. at least one pigment; and
b. at least one water absorbent present in an amount effective to reduce efflorescence in concrete pigmented with the granular pigment composition.

16. The granular pigment composition of claim 15, further comprising from 0% to about 4.2% of water.

17. The granular pigment composition of claim 15, wherein the water absorbent is alkali swellable.

18. The granular pigment composition of claim 17, wherein the water absorbent is an alkali swellable cross-linked polyacrylate polymer.

19. The granular pigment composition of claim 18, further characterized by an acidic to neutral pH.

20. The granular pigment composition of claim 15, wherein the water absorbent is a water insoluble cellulose or a derivative thereof.

21. The granular pigment composition of claim 15, wherein the at least one pigment is selected from the group consisting of carbon, a manganese oxide and an iron oxide.

22. The granular pigment composition of claim 15, wherein the granule has a particle size of about 20 microns or more.

23. The granular pigment composition of claim 15, further comprising at least one binder for promoting the dispersal of the pigment in a concrete.

24. The granular pigment composition of claim 15, made by spray-drying the pigment, binder, and water absorbent.

25. The granular pigment composition of claim 15, made by compacting the pigment, optionally a binder, and water absorbent.

26. The granular pigment composition of claim 1, made by briquetting the pigment, binder, and water absorbent.

27. The granular pigment composition of claim 15, made by pin-milling the pigment, binder, and water absorbent.

28. The granular pigment composition of claim 15, made by drum drying the pigment, binder, and water absorbent.

29. The granular pigment composition of claim 15, made by belt drying the pigment, binder, and water absorbent.

30. The granular pigment composition of claim 15, made by agglomerating the pigment, binder, and water absorbent.

31. The granular pigment composition of claim 15, made by:
a. forming the ingredients of the composition into at least two types of granules having different compositions; and
b. blending the types of granules having different compositions.
